(19) United States
(12) Patent Application Publication
(10) Pub. No.: US 2008/0014943 A1
(43) Pub. Date: Jan. 17, 2008

(54) METHOD AND APPARATUS FOR HANDOFF DECISION IN MOBILE COMMUNICATION SYSTEM

(75) Inventors: Chi-Hun Ahn, Hwaseong-si (KR); Young-Min Kwon, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/774,231

(22) Filed: Jul. 6, 2007

(30) Foreign Application Priority Data
Jul. 13, 2006 (KR) 2006-0065805

(51) Int. Cl. H04Q 7/20

(52) U.S. Cl. 455/436

(57) ABSTRACT

Provided are a method and an apparatus for a handoff decision in a mobile communication system. The method includes comparing a threshold value with a measured Received Signal Strength (RSS) of a serving base station, and if the threshold value is greater than the measured RSS, operating a handoff timer; calculating an approximate RSS using the RSS, which has experienced a forward link power control, and a handoff weight, and comparing the threshold value with the approximate RSS. If the approximate RSS is less than the threshold value, a handoff is performed. Thus, an accurate channel state is considered to determine whether to handoff.

### PRIORITY

This application claims priority under 35 U.S.C. §119 to an application filed in the Korean Intellectual Property Office on Jul. 13, 2006 and assigned Serial No. 2006-65805, the contents of which arc incorporated herein by reference.

### BACKGROUND OF THE INVENTION

1. Field of the Invention

The present invention relates generally to a method and an apparatus for a handoff decision in a mobile communication system, and in particular, to a handoff decision method and apparatus for applying a forward link power control technique and a handoff weight to reduce a ping-pong phenomenon, call dropping, and call blocking occurring during an execution of an handoff so as to relieve a load applied to a mobile communication system.

2. Description of the Related Art

Handoff technology is adopted in Code Division Multiple Access (CDMA), Global System for Mobile Communication (GSM), and Wideband Code Division Multiple Access (WCDMA) mobile communication systems in order to ensure mobility of mobile communication terminals. Each time a mobile communication terminal travels from a first serving cell or sector to a second cell or sector, a traffic channel of the first serving cell or sector is switched over to a traffic channel of the second cell or sector in order to maintain a call. This procedure is called a handoff. For reference, a term “Handover” is used instead of the term “Handoff” in a GSM system.

In general, a handoff is classified into two types: a hard handoff and a soft handoff. The hard handoff is a technique for immediately handing over a call to a cell transmitting a stronger signal than that transmitted from a currently serving cell and is used in a GSM system. The hard handoff does not preset a traffic channel and thus momentarily drops a call. With regard to the soft handoff, a target cell and its traffic channel are constituted before the soft hand off is executed. Thereafter, when it becomes difficult to maintain a traffic channel of a serving cell, a mobile communication terminal uses the traffic channel of the target cell and breaks the traffic channel of the serving cell according to an instruction of a base station. Thus, traffic channels of a currently serving cell and a cell to which a handoff is to be performed are separately allocated for the soft handoff. The soft handoff is currently used in a CDMA system.

In hard and soft handoffs as described above, a Received Signal Strength (RSS) is measured, and a hard handoff begins if the RSS is smaller than a specific threshold value. If the RSS remains smaller than the specific threshold value after a period of time elapses, a handoff command is given to a mobile communication terminal.

FIG. 1 illustrates a handoff procedure performed in a mobile communication system according to the prior art.

Referring to FIG. 1, a mobile communication terminal during a call periodically transmits a measurement report message to a serving cell in step 101. The measurement report message includes RSSs of the serving cell and a neighboring cell. For example, the measurement report message includes an RSS of a pilot channel in a CDMA system and an RSS of a Broadcast Control CHannel (BCCH) in a GSM system.

The mobile communication terminal proceeds to step 103 to compare the RSSs with a specific threshold value for a handoff. If the specific threshold value is greater than the RSSs in step 103, the mobile communication terminal proceeds to step 105 to operate a handoff timer at a time t1, which handoff timer allows the mobile communication terminal to wait for an operation time of the handoff timer and then perform a handoff according to the comparison result between the specific threshold value and the RSSs.

If the specific threshold value is less than or equal to the RSSs in step 103, the mobile communication terminal returns to step 101.

In step 107, the mobile communication terminal checks whether the handoff timer has ended its operation at a time t2. If it is checked in step 107 that the handoff timer has ended its operation at the time t2, the mobile communication terminal proceeds to step 109 to compare the specific threshold value with an RSS which is measured at the time t2 when the handoff timer ends its operation.

If the specific threshold value is greater than the RSS in step 109, the mobile communication terminal proceeds to step 111 to complete the handoff to a target cell.

If the specific threshold value is less than or equal to the RSS in step 109, the mobile communication terminal returns to step 101.

Thereafter, the algorithm of the handoff procedure is ended.

If the handoff described with reference to FIG. 1 is a hard handoff, a current traffic channel is momentarily broken, and a traffic channel is allocated to a target cell to maintain a call. Thus, if the mobile communication terminal moves within a handoff area, i.e., an overlap area between two cells, a ping-pong phenomenon may occur due to frequent executions of a handoff. Also, if the mobile communication terminal requests the traffic channel of the target cell but the target cell does not include an extra traffic channel, call dropping occurs. Thus, a call dropping rate can increase due to frequent executions of the handoff.

FIG. 2 illustrates a ping-pong phenomenon occurring due to frequent executions of a handoff according to the prior art.

Referring to FIG. 2, a handoff is frequently performed due to a movement of a mobile communication terminal 200 within a handoff area (an overlap area between a serving cell 202 and a target cell 204).

If the mobile communication terminal 200 moves around boundaries of the serving cell 202 and the target cell 204, particularly in a direction perpendicular to both base stations, RSSs of the serving cell 202 and the target cell 204 are frequently varied according to changes of a position of the mobile communication terminal 200. Thus, the handoff is frequently performed.

In a soft handoff, the mobile communication terminal 200 is connected to a traffic channel of the target cell 204 and then breaks a traffic channel of the serving cell 202 at the beginning of the handoff. Thus, a ping-pong phenomenon may be reduced. However, a dedicated-channel of the target cell 204 must be pre-allocated during the execution of the handoff. If the target cell 204 does not include an extra traffic channel, a probability of an initial call being blocked is increased.

Accordingly, there is needed a handoff decision method and apparatus for preventing call quality deterioration due to such instances as a ping-pong phenomenon, call dropping and call blocking.

### SUMMARY OF THE INVENTION

An aspect of the present invention is to substantially solve at least the above problems and/or disadvantages and to provide at least the advantages below. Accordingly, an aspect of the present invention is to provide a handoff decision method and apparatus for reducing a ping-pong phenomenon, call dropping, and call blocking and ensuring continuity of a call.

Another aspect of the present invention is to provide a handoff decision method and apparatus for reducing a number of frequent executions of a handoff.

A further aspect of the present invention is to provide a method and an apparatus for a handoff decision using an RSS to which a forward link power control and a weight are applied.

The above aspects are achieved by providing a point-to-point emulation apparatus and method in a broadband wireless communication system.

According to the present invention, there is provided a method for a handoff decision in a mobile communication system, including comparing a threshold value with a measured RSS of a serving base station, and if the threshold value is greater than the measured RSS, operating a handoff timer, and calculating an approximate RSS using a handoff weight and the RSS which has experienced a forward link power control, after the handoff timer ends its operation; and comparing the threshold value with the approximate RSS. If the approximate RSS is less than the threshold value, performing a handoff to a target base station.

According to the present invention, there is provided an apparatus for a handoff decision in a mobile communication system, including a handoff timer unit for comparing a measured RSS of a serving base station with a threshold value, and operating a handoff timer if the threshold value is greater than the measured RSS, a handoff calculator for calculating an approximate RSS using the RSS which has experienced a forward link power control and a handoff weight after the hand timer ends its operation, and a controller for comparing the approximate RSS with the threshold value, and if the approximate RSS is smaller than the threshold value, performing a handoff to a target base station.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a method for a handoff decision according to the prior art;

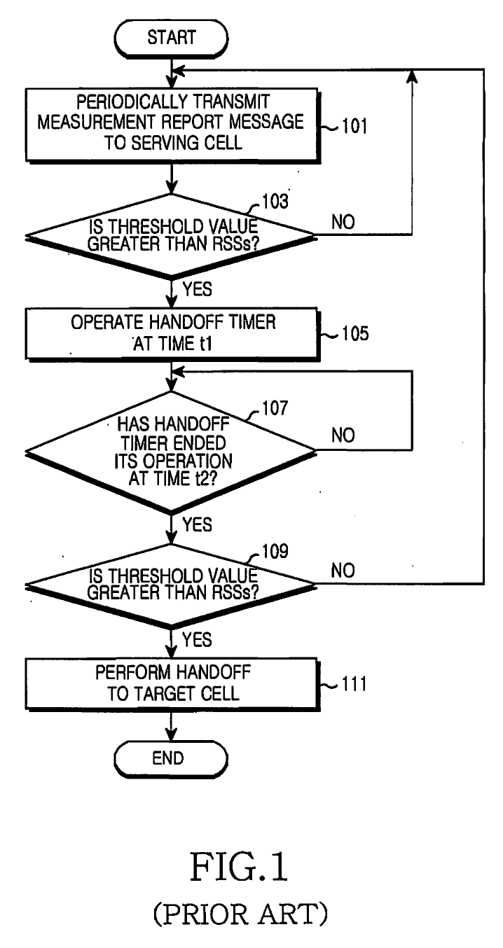

FIG. 2 illustrates a ping-pong phenomenon occurring during an execution of a handoff according to the prior art;

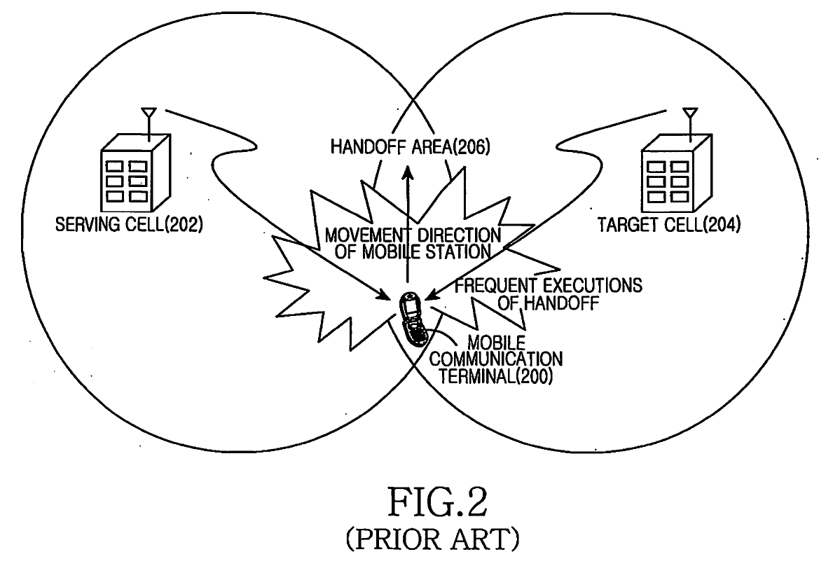

FIG. 3 is a flowchart of a method for a handoff decision in a mobile communication system according to the present invention;

FIG. 4 is a flowchart of a method for a handoff decision in a mobile communication system according to the present invention;

FIG. 5 illustrates a method for a handoff decision in a mobile communication terminal according to the present invention; and

FIG. 6 illustrates a method for a handoff decision in a mobile communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention provides a handoff decision method and apparatus for utilizing an approximate RSS to which a forward link power control and a handoff weight are applied for a period of time in a normal handoff method in order to reduce a number of frequent executions of a handoff in a cell overlap area.

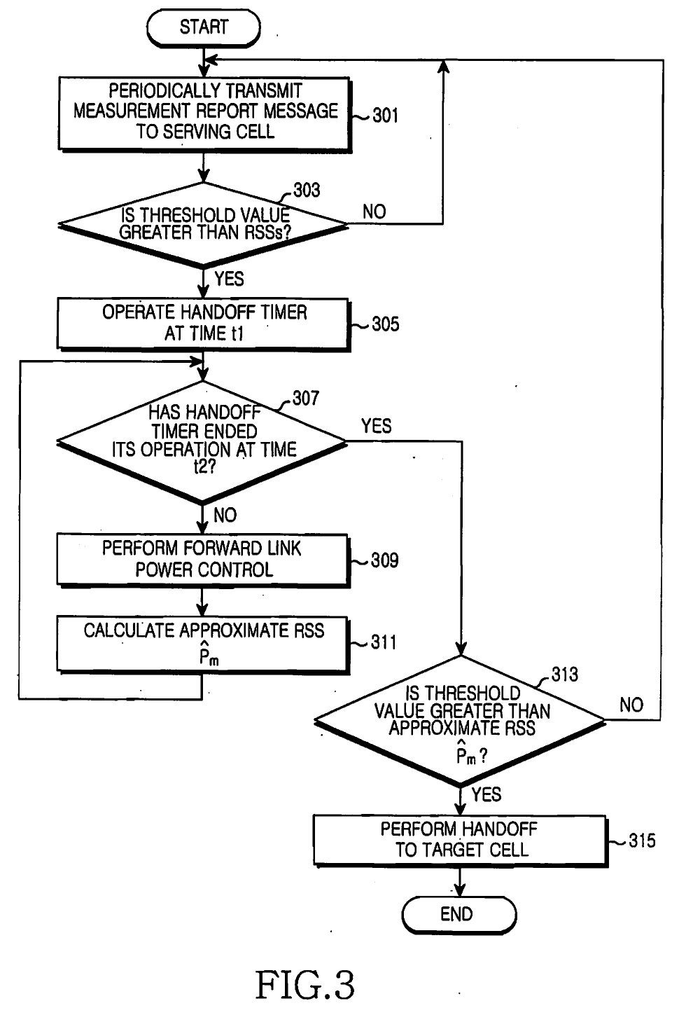

FIG. 3 is a flowchart of a method for a handoff decision in a mobile communication system according to the present invention.

Referring to FIG. 3, a mobile communication terminal during a call periodically transmits a measurement report message to a serving cell in step 301. The measurement report message includes RSSs of the serving cell and a neighboring cell measured by the mobile communication terminal.

The serving cell proceeds to step 303 to compare the RSSs with a specific threshold value for a handoff with reference to the measurement report message. If the specific threshold value is greater than the RSSs in step 303, the serving cell proceeds to step 305 to operate a handoff timer at a time t1. After the handoff timer operates for a period of time, the serving cell re-compares the RSSs with the specific threshold value to decide a handoff.

If the specific threshold value is less than or equal to the RSSs in step 303, the serving cell returns to step 301.

In step 307, the serving cell determines whether the handoff timer has ended its operation at a time t2. If it is determined in step 307 that the handoff timer has not ended its operation at the time t2, the serving cell proceeds to step 309 to perform a forward link power control. When the mobile communication terminal during the call is positioned in a boundary area of a cell in which multi-path fading, noise, or interference is high, the forward link power control is used to increase and/or decrease a power level of the cell so as to maintain call quality of all calls. Thus, the mobile communication terminal positioned within a cell overlap area ensures a constant received level on which a call quality can be maintained.

In step 311, the serving cell calculates an approximate RSS \hat{P}ₘ and then returns to step 307.

Here, if a number of performances of the forward link power control for a time Δt is n, the approximate RSS \hat{P}ₘ is calculated as shown in Equation (1).

$${\hat{P}}_{m} = \frac{{\sum }_{w = 1}^{n} {wP}_{w}}{{\sum }_{w = 1}^{n} w} \qquad ( 1 )$$

In Equation (1), n denotes the number of the performances of the forward link power control for time Δt, P_{w} (1, 2, 3, . . . , and n) denotes a strength of a signal which has experienced the forward link power control, and w denotes a weight of each of signals which have experienced the forward link power control. To calculate the approximate RSS \hat{P}ₘ, a large weight is applied to a signal transmitted at a closest time to an end moment of the time Δt for which the handoff timer operates.

If it is determined in step 307 that the handoff timer has ended its operation at the time t2, the serving cell goes to step 313 to compare the specific threshold value with the approximate RSS \hat{P}ₘ calculated in step 311. If the specific threshold value is greater than the approximate RSS \hat{P}ₘ in step 313, the serving cell proceeds to step 315 to perform a handoff to a target cell. Here, the forward link power control contributes to maintaining the approximate RSS \hat{P}ₘ on the constant received level on which the call quality is maintained. In other words, since the call quality is maintained constant regardless of a movement distance of the mobile communication terminal, a number of executions of the handoff is reduced. Also, because the approximate RSS \hat{P}ₘ is calculated using a weight average, a determination is made as to whether the handoff is to be performed in consideration of an accurate state of a wireless channel.

If the specific threshold value is less than or equal to the RSSs in step 313, the serving cell returns to step 301.

Thereafter, the handoff algorithm of the present invention is ended.

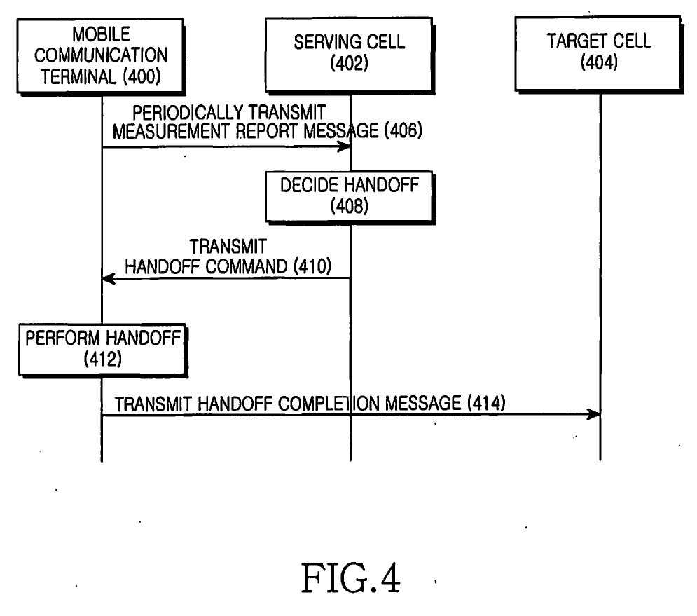

FIG. 4 is a flowchart of a method for a handoff decision in a mobile communication system according to the present invention.

Referring to FIG. 4, a mobile communication terminal 400 during a call periodically transmits a measurement report message 406 to a serving cell 402. The measurement report message 406 includes information regarding RSSs of the serving cell 402 and a neighboring cell.

The serving cell 402 performs a forward link power control while a handoff timer operates, to calculate an approximate RSS. The serving cell 402 then compares the approximate RSS with a specific threshold value for a handoff. If the specific threshold value is greater than the approximate RSS, the serving cell 402 makes a handoff decision 408 and transmits a handoff command message 410 to the mobile communication terminal 400. The approximate RSS is calculated as shown above in Equation 1.

The mobile communication terminal 400 receives the handoff command message 410, performs a handoff 412 and transmits a handoff completion message 414 to a target cell 404.

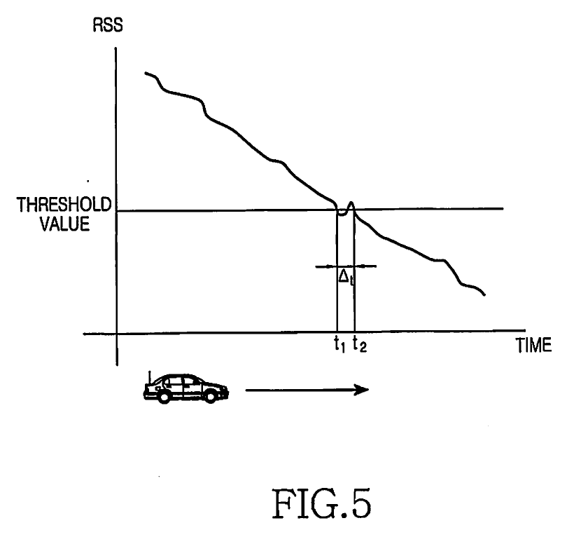

FIG. 5 illustrates a method for a handoff decision in a mobile communication terminal according to the present invention.

Referring to FIG. 5, when a user transports a mobile communication terminal in a vehicle and thus travels away from a serving cell, an RSS is reduced with time.

If an RSS transmitted from the serving cell reaches a specific threshold value at a time t1, the serving cell operates a handoff timer for a time Δt, during which time the serving cell performs a forward link power control and calculates an approximate RSS. If the handoff timer ends its operation at a time t2, the serving cell compares the approximate RSS with a specific threshold value for a handoff at the time t2. If the specific threshold value is greater than the approximate RSS, the mobile communication terminal performs a handoff to a target cell.

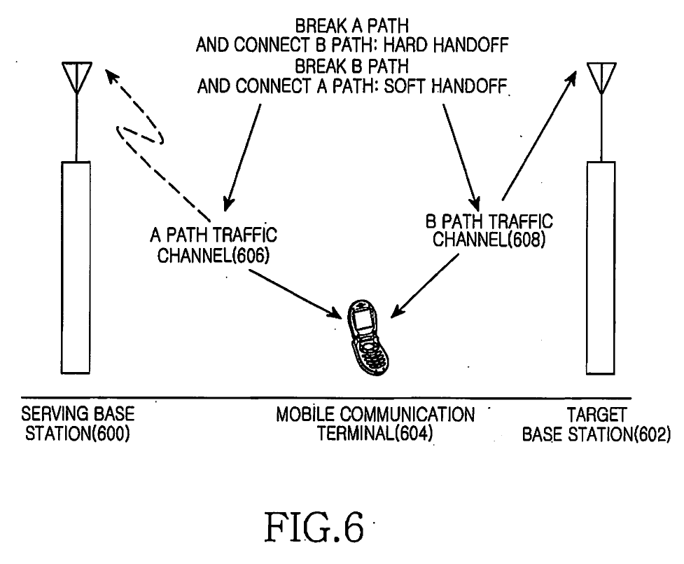

FIG. 6 illustrates a method for a handoff decision in a mobile communication system according to the present invention.

Referring to FIG. 6, a serving base station 600 senses a measurement report message, which is periodically transmitted from a mobile communication terminal 604 moving during a call, in order to check whether an RSS is decreased to a pre-set threshold value or less. If the RSS received to the mobile communication terminal 604 is decreased to the pre-set threshold value or less, the serving base station 600 determines that the mobile communication terminal 604 is positioned around boundaries of a serving cell and a target cell and reports the determination result to a higher base station. The higher base station investigates a neighboring cell in which the mobile communication terminal 604 receives a signal on a better level than a signal transmitted from the serving base station 600. If a receiving state of the signal received from the neighboring cell is better than that of the signal transmitted from the serving base station 600, the higher base station transmits a handoff request message to a target base station 602 and instructs the mobile communication terminal 604 to be connected to the target base station 602 through a traffic channel so as to achieve a handoff. In a hard handoff, a traffic channel 606 through which the mobile communication terminal 604 is connected to the serving base station 602 is broken before the mobile communication terminal 604 begins communication with the serving base station 600. Thus, when the hard handoff is performed, a connection briefly drops, thereby deteriorating a call quality. In a soft handoff, the mobile communication terminal 604 occupies both traffic channels 606 and 608 through which the mobile communication terminal 604 are connected to the serving and target base stations 600 and 602, respectively. If the RSS is decreased to a specific threshold value or less, the mobile communication terminal 604 breaks the traffic channel 606 of the serving base station 600.

As described above, in a method and an apparatus for a handoff decision in a mobile communication system according to the present invention, an accurate state of a channel is reflected to determine whether a handoff is to be performed. Thus, a ping-pong phenomenon, and call dropping and call blocking problems are reduced. Also, a load applied to the mobile communication system during the handoff is reduced.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for a handoff decision in a mobile communication system, comprising:
comparing a threshold value with a measured Received Signal Strength (RSS) of a serving base station, and operating a handoff timer if the threshold value is greater than the measured RSS;
calculating, during an operation of the handoff timer, an approximate RSS using a handoff weight and the RSS, which has experienced a forward link power control; and
comparing the threshold value with the approximate RSS, and if the approximate RSS is less than the threshold value, performing a handoff to a target base station.

2. The method of claim 1, further comprising performing the forward link power control for an operation time of the handoff timer.

3. The method of claim 1, wherein the handoff weight increases at a closest time to an ending time of the handoff timer.

4. The method of claim 1, wherein the approximate RSS \hat{P}ₘ is calculated by the following Equation,
$${\hat{P}}_{m} = \frac{{\sum }_{w = 1}^{n} {wP}_{w}}{{\sum }_{w = 1}^{n} w}$$
wherein P_{w} denotes an RSS which has experienced the forward link power control, w denotes a weight of each of RSSs which have experienced the forward link power control, and n denotes a number of performances of the forward link power control during the operation of the handoff timer.

5. The method of claim 1, further comparing the threshold value with the approximate RSS, and if the approximate RSS is larger than the threshold value, maintaining service with the serving base station.

6. An apparatus for performing a handoff decision in a mobile communication system, comprising:
a handoff timer unit for comparing a measured Received Signal Strength (RSS) of a serving base station with a threshold value, and operating a handoff timer if the threshold value is greater than the measured RSS;
a handoff calculator for calculating an approximate RSS using the RSS, which has experienced a forward link power control; and
a controller for comparing the approximate RSS with the threshold value, and if the approximate RSS is less than the threshold value, performing a handoff to a target base station.

7. The apparatus of claim 6, wherein the forward link power control is performed for an operation time of the handoff timer.

8. The apparatus of claim 6, wherein the handoff weight increases at a closest time to an ending time of the handoff timer.

9. The apparatus of claim 6, wherein the approximate RSS \hat{P}ₘ is calculated by the following Equation,
$${\hat{P}}_{m} = \frac{{\sum }_{w = 1}^{n} {wP}_{w}}{{\sum }_{w = 1}^{n} w}$$
wherein P_{w} denotes an RSS which has experienced the forward link power control, w denotes a weight of each of RSSs which have experienced the forward link power control, and n denotes a number of performances of the forward link power control during the operation of the handoff timer.

10. The apparatus of claim 6, further comparing the threshold value with the approximate RSS, and if the approximate RSS is larger than the threshold value, maintaining service with the serving base station.

11. A method for a handoff decision in a mobile communication base station, comprising:
receiving a measured Received Signal Strength (RSS) from a mobile communication terminal;
operating a handoff timer if a threshold value is greater than the measured RSS;
calculating, during an operation of the handoff timer, an approximate RSS using a handoff weight and the RSS, which has experienced a forward link power control; and
transmitting a handoff command to the a mobile communication terminal if the approximate RSS is less than the threshold value.

12. The method of claim 11, further comprising performing the forward link power control for an operation time of the handoff timer.

13. The method of claim 11, wherein the handoff weight increases at a closest time to an ending time of the handoff timer.

14. The method of claim 11, wherein the approximate RSS \hat{P}ₘ is calculated by the following Equation,
$${\hat{P}}_{m} = \frac{{\sum }_{w = 1}^{n} {wP}_{w}}{{\sum }_{w = 1}^{n} w}$$
wherein P_{w} denotes an RSS which has experienced the forward link power control, w denotes a weight of each of RSSs which have experienced the forward link power control, and n denotes a number of performances of the forward link power control during the operation of the handoff timer.

15. A computer-readable recording medium having recorded thereon a program for a handoff decision in a mobile communication system, comprising:
a first code segment, for comparing a threshold value with a measured Received Signal Strength (RSS) of a serving base station, and operating a handoff timer if the threshold value is greater than the measured RSS; and
a second code segment, for calculating, during an operation of the handoff timer, an approximate RSS using a handoff weight and the RSS, which has experienced a forward link power control; and
a third code segment, for comparing the threshold value with the approximate RSS, and if the approximate RSS is less than the threshold value, performing a handoff to a target base station.
